(19) United States
(12) Patent Application Publication
(10) Pub. No.: US 2022/0288859 A1
(43) Pub. Date: Sep. 15, 2022

(54) FILAMENT MONITORING SYSTEM AND METHOD

(71) Applicant: Stratasys, Inc., Eden Prairie, MN (US)

(72) Inventors: Colin Schiel, Chaska, MN (US); Benjamin L. Braton, Otsego, MN (US); Benjamin N. Dunn, Savage, MN (US); Bryan Migliori, Lakeville, MN (US); Brett Johnson, Roseville, MN (US)

(21) Appl. No.: 17/198,869

(22) Filed: Mar. 11, 2021

(51) Int. Cl. B29C 64/393; B29C 64/118; B29C 64/336; B29C 64/209; B33Y 10/00; B33Y 30/00; B33Y 50/02

(52) U.S. Cl. CPC B29C 64/393; B29C 64/118; B29C 64/336; B29C 64/209; B33Y 10/00; B33Y 30/00; B33Y 50/02

(57) ABSTRACT

A method of loading filament into a 3D printer that build parts by fused deposition modeling processes includes providing a 3D printer having a receptacle configured for accepting a plug-in connector from a filament supply. The method further includes providing a filament supply having a container configured to retain a supply of a filament, a filament guide tube having a length, an inlet end attached to the container and an outlet end, and a connector at the outlet end of the filament guide tube. The connector has a geometry allowing it to be plugged into the receptacle and comprises a conduit having an entrance for accepting the outlet end of the filament guide tube and an exit for passing the filament into the printer. The method includes causing a signal to be emitted proximate the receptacle such that when the plug-in connector is inserted into the receptable, light shines through the connector to inform the operator of a filament loading status.

### BACKGROUND

The present disclosure relates to additive manufacturing systems for 3D printing of parts by material extrusion techniques. In particular, the present disclosure relates to the loading of filament into and the unloading of filament from a print head of the 3D printer. All references disclosed herein are incorporated by reference.

Additive manufacturing, also called 3D printing, is generally a process in which a three-dimensional (3D) part is built by adding material to form a 3D part rather than subtracting material as in traditional machining. Using one or more additive manufacturing techniques, a three-dimensional solid part of virtually any shape can be printed from a digital model of the part by an additive manufacturing system, commonly referred to as a 3D printer. A typical additive manufacturing work flow includes slicing a three-dimensional computer model into thin cross sections defining a series of layers, translating the result into two-dimensional position data, and transmitting the data to a 3D printer which manufactures a three-dimensional structure in an additive build style. Additive manufacturing entails many different approaches to the method of fabrication, including material extrusion, ink jetting, selective laser sintering, powder/binder jetting, electron-beam melting, electrophotographic imaging, and stereolithographic processes.

In a typical extrusion-based additive manufacturing system (e.g., fused deposition modeling systems developed by Stratasys, Inc., Eden Prairie, Minn.), a 3D part may be printed from a digital representation of the printed part by extruding a viscous, flowable thermoplastic or filled thermoplastic material from a print head along toolpaths at a controlled extrusion rate. The extruded flow of material is deposited as a sequence of roads onto a substrate, where it fuses to previously deposited material and solidifies upon a drop in temperature. The print head includes a liquefier which receives a supply of the thermoplastic material in the form of a flexible filament, and a nozzle tip for dispensing molten material. A filament drive mechanism engages the filament such as with a drive wheel and a bearing surface, or pair of toothed-wheels, and feeds the filament into the liquefier where the filament is heated to a molten pool. The unmelted portion of the filament essentially fills the diameter of the liquefier tube, providing a plug-flow type pumping action to extrude the molten filament material further downstream in the liquefier, from the tip to print a part, to form a continuous flow or toolpath of resin material. The extrusion rate is unthrottled and is based only on the feed rate of filament into the liquefier, and the filament is advanced at a feed rate calculated to achieve a targeted extrusion rate, such as is disclosed in Comb U.S. Pat. No. 6,547,995.

In a system where the material is deposited in planar layers, the position of the print head relative to the substrate is incremented along an axis (perpendicular to the build plane) after each layer is formed, and the process is then repeated to form a printed part resembling the digital representation. In fabricating printed parts by depositing layers of a part material, supporting layers or structures are typically built underneath overhanging portions or in cavities of printed parts under construction, which are not supported by the part material itself. A support structure may be built utilizing the same deposition techniques by which the part material is deposited. A host computer generates additional geometry acting as a support structure for the overhanging or free-space segments of the printed part being formed. Support material is then deposited pursuant to the generated geometry during the printing process. The support material adheres to the part material during fabrication and is removable from the completed printed part when the printing process is complete.

A multi-axis additive manufacturing system may be utilized to print 3D parts using fused deposition modeling techniques. The multi-axis system may include a robotic arm movable in six degrees of freedom. The multi-axis system may also include a build platform movable in two or more degrees of freedom and independent of the movement of the robotic arm to position the 3D part being built to counteract effects of gravity based upon part geometry. An extruder may be mounted at an end of the robotic arm and may be configured to extrude material with a plurality of flow rates, wherein movement of the robotic arm and the build platform are synchronized with the flow rate of the extruded material to build the 3D part. The multiple axes of motion can utilize complex tool paths for printing 3D parts, including single continuous 3D tool paths for up to an entire part, or multiple 3D tool paths configured to build a single part. Use of 3D tool paths can reduce issues with traditional planar toolpath 3D printing, such as stair-stepping (layer aliasing), seams, the requirement for supports, and the like. Without a requirement to print layers of a 3D part in a single build plane, the geometry of part features may be used to determine the orientation of printing.

As 3D printers become larger, the distance from the control panel to the filament loading area having a receptacle on the 3D printer can be obstructed and difficult to monitor. There is a need to provide signals to the operator regarding filament status, as well as filament loading and unloading operations that can be visually monitored proximate the receptacle, as well as away from the control panel user interface.

### SUMMARY

An aspect of the present disclosure is directed to a method of loading filament into a 3D printer that build parts by fused deposition modeling processes. The method includes providing a 3D printer having a receptacle configured for accepting a plug-in connector from a filament supply. The method further includes providing a filament supply having a container configured to retain a supply of a filament, a filament guide tube having a length, an inlet end attached to the container and an outlet end, and a connector at the outlet end of the filament guide tube. The connector has a geometry allowing it to be plugged into the receptacle and comprises a conduit having an entrance for accepting the outlet end of the filament guide tube and an exit for passing the filament into the printer. The method includes causing a signal to be emitted proximate the receptacle such that when the plug-in connector is inserted into the receptable, light shines through the connector to inform the operator of a filament loading status.

Another aspect of the present disclosure relates a 3D printer having a print head configured to receive a filament, melt the filament, and deposit the melted filament to form a 3D part. The 3D printer includes a filament supply having a container configured to retain a supply of a filament, a filament guide tube having a length with an n inlet end attached to the container and an outlet end. A plug-in connector is secured to the outlet end of the filament guide tube, the connector constructed of at least partially of a light-transmissive material. The 3D printer includes a receptacle spaced from the print head, where the receptacle has a conduit having an entrance for accepting the outlet end of the filament guide tube and an exit for passing the filament toward the print head. The 3D printer further includes a light source proximate the receptacle wherein the light source is configured to emit a light signal proximate the receptacle, such that when the connector is inserted into the receptacle light shines through the connector to inform the operator of a filament loading status.

### BRIEF DESCRIPTION OF THE DRAWINGS

FIG. 1 is a perspective view of a schematic additive manufacturing system.

FIG. 2 is a perspective view of exemplary print heads of the additive manufacturing system.

FIG. 2 is a perspective view of the exemplary large format additive manufacturing system.

FIG. 4 is a view of receptacles for receiving a connector of a consumable assembly

FIG. 5 is a back view of the receptacles of FIG. 4.

FIG. 6 is a front view of an exemplary connector of a consumable assembly.

FIG. 7 is a front view of another exemplary connector of a consumable assembly.

FIG. 8 is a view of the receptacles and connectors prior to being inserted into the receptacles with light emitted from the receptacles.

FIG. 9. is a view of the connectors inserted into the receptacles with light being emitted from each connector.

FIG. 10 is a flow chart for unloading filament from the 3D printer.

FIG. 11 is a flow chart for loading filament into the 3D printer.

### DETAILED DESCRIPTION

The present disclosure is directed to method for monitoring the filament loading status of a consumable filament with a print head of a 3D printer of an additive manufacturing system. The disclosed method utilizes light signals emitted proximate a filament-loading receptacle in the 3D printer to indicate a machine status of a filament supplied to the printer. Utilizing light signals proximate the receptacle allows the operator to monitor the loading and/or unloading process and other machine status of the filament even when the operator is located at a distance from the printer, or a distance from the user interface or the filament-loading area of the printer.

The present method allows the operator to visually monitor the machine status of a filament by utilizing one or more exemplary filament connectors or keys, such as are as described in Swanson et al. U.S. Patent Application Publication 2020/0307070, the contents of which is incorporated by reference in its entirety. The connector or key has a main body that is constructed at least partially of a light-transmissive material (e.g., a transparent or translucent material; one which is permeable to light), where the main body is configured to be plugged into a receptacle on the printer. One or more LEDs that are controllable to emit light signals in the receptacle, such that when a connector is plugged into the receptacle, the light signals transmit through the light-transmissive material of the connector and are visible outside of the printer. The LEDs can generate light signals by emitting different colors of light indicative of status (for example, red indicating a filament loading error, and blue indicating an operating state) or the light signals can be similarly colored but blink at different rates or emit solid light to provide signals to the operator the state of the loading and/or unloading process. In this manner, the operator is provided a signal that indicates the status of the loading and/or unloading processes or action that is required such that the operator can monitor the process from a distance.

In another embodiment, the LED blinking lights can be located or embedded within the exemplary filament connector. The light may also be transmitted within the filament tubing, when light-transmissive tubing is utilized. Light is able to transmit through the light-transmissive material that forms the connector, so that the connector appears to be illuminated by light from the LEDs.

In some embodiments, multiple connectors are provided, each having a unique geometry based on the associated material or print head, and thus may be referred to as a key. Multiple receptacles are then likewise provided in the 3D printer each receptacle having a configuration complimentary to the geometry of a provided key, such that each key can be positioned within a corresponding receptacle having a complementary configuration to that of the key. However, it is within the scope of the present disclosure to utilize a plurality of unitary connectors each having the same configuration.

While it is typical to use a monolithic, elastomeric connector or key, other light-transmissive materials can be utilized and/or multi-component connectors can be utilized to provide the desired transmissivity so that the light signals will be emitted and is visible to the operator. Additionally, in some embodiments the filament guide tube can be constructed of a transparent or translucent material such that as the light is emitted into the filament connector or key, the light also is emitted along at least a portion of the filament guide tube.

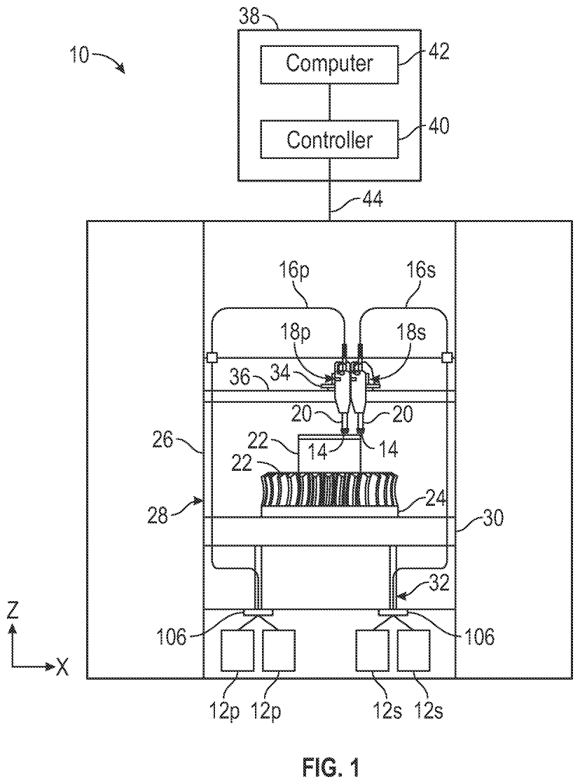

The present disclosure may be used with any suitable extrusion-based 3D printer. For example, FIG. 1 illustrates a schematic view of an exemplary 3D printer 10 that has a substantially horizontal print plane, and where the part is printed and indexed in a substantially vertical direction. Parts are printed in a layer by layer manner using two print heads 18p for part material and 18s for support material or printed with part material alone. The illustrated 3D printer 10 uses four consumable assemblies, two consumable assemblies 12p for part material and two consumable assemblies 12s for support material. Each consumable assembly 12p and 12s is a removable, and replaceable supply device such that dual supplies of consumable filament of part material and dual supplies of consumable material for support material can be retained and utilized in a single 3D printer 10. All of the consumable assemblies 12p and 12s may be identical or different in composition. Each consumable assembly 12 may retain the consumable filament on a wound spool, a spool-less coil, or other supply arrangement, such as discussed for example in Turley et al. U.S. Pat. No. 7,063,285; Taatjes at al., U.S. Pat. No. 7,938,356; and Mannella et al., U.S. Pat. Nos. 8,985,497 and 9,073,263. While four assemblies are illustrated, the present disclosure is not limited to a 3D printer with four assemblies. Rather, the 3D printer of the present disclosure can utilize any number of assemblies including two or more assemblies containing the same or different consumable materials.

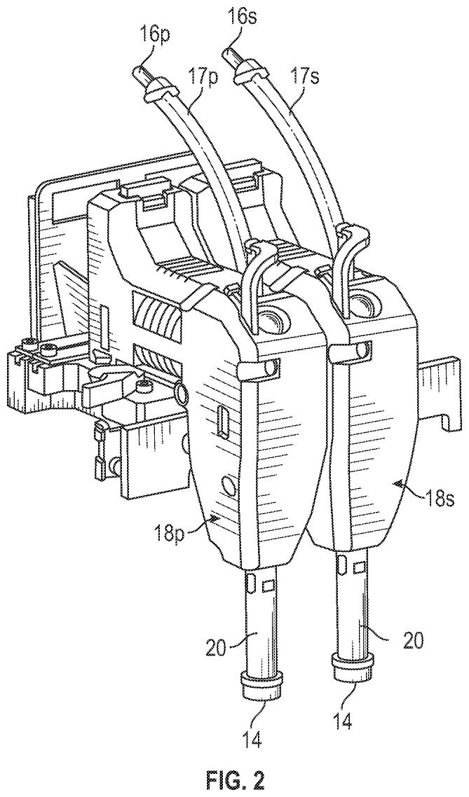

As shown in FIG. 2, each print head 18p and 18s is a device comprising a housing that retains a liquefier 20 having a nozzle tip 14. A filament feed path 16p and 16s interconnects each consumable assembly 12p and 12s and print head 18p and 18s, and provides a filament feed path from the filament supply to the print head, where the filament feed paths 16p and 16s are substantially sealed from ambient conditions. Upper ends of feed path 16p and 16s can be attached to the print heads 18p and 18s using end piece 17p and 17s.

Exemplary 3D printer 10 prints parts or models and corresponding support structures (e.g., 3D part 22 and support structure 24) from the part and support material filaments, respectively, of consumable assemblies 12, by extruding roads of molten material along toolpaths. During a build operation, successive segments of consumable filament are driven into print head 18 where they are heated and melt in liquefier 20. The melted material is extruded through nozzle tip 14 in a layer-wise pattern to produce printed parts. Suitable 3D printers 10 include fused deposition modeling systems developed by Stratasys, Inc., Eden Prairie, Minn. under the trademark “FDM”.

As shown, the 3D printer 10 includes system cabinet or frame 26, chamber 28, platen 30, platen gantry 32, head carriage 34, and head gantry 36. Cabinet 26 may include container bays configured to receive consumable assemblies 12p and 12s. In alternative embodiments, the container bays may be omitted to reduce the overall footprint of 3D printer 10. In these embodiments, consumable assembly 12 may stand proximate to printer 10.

Chamber 28 contains platen 30 for printing 3D part 22 and support structure 24. Chamber 28 may be an enclosed environment and may be heated (e.g., with circulating heated air) to reduce the rate at which the part and support materials solidify after being extruded and deposited (e.g., to reduce distortion and curling). A typical chamber includes a thermal insulator that allows the print heads 18p and 18s to be located outside the heated space, while moving in a heated build envelope, and printing in a plane, whether x-y, x-z or y-z depending upon the configuration of the printer.

In alternative embodiments, chamber 28 may be omitted and/or replaced with different types of build environments. For example, 3D part 22 and support structure 24 may be printed in a build environment that is open to ambient conditions or may be enclosed with alternative structures (e.g., flexible curtains).

Platen assembly 30 is a platform on which 3D part 22 and support structure 24 are printed in a layer-by-layer manner and is supported by platen gantry 32. In some embodiments, platen assembly 30 may engage and support a build substrate. Platen gantry 32 is a gantry assembly configured to move platen assembly 30 along (or substantially along) the vertical z-axis.

Head carriage 34 is a unit configured to receive and retain print heads 18p and 18s and is supported by head gantry 36. In the shown embodiment, head gantry 36 is a mechanism configured to move head carriage 34 (and the retained print heads 18p and 18s) in (or substantially in) a horizontal x-y plane above platen assembly 30.

In an alternative embodiment, platen assembly 30 may be configured to move in the horizontal x-y plane within chamber 28, and head carriage 34 (and print heads 18p and 18s) may be configured to move along the z-axis. Other similar arrangements may also be used such that one or both of platen assembly 30 and print heads 18p and 18s are moveable relative to each other.

FIG. 2 illustrates an example embodiment of two print heads 18p and 18s which include the print head drives which drive filament into the print heads. The shown print heads 18p and 18s are similarly configured to receive a consumable filament, melt the filament in liquefier 20 to product a molten material, and deposit the molten material from a nozzle tip 14 of liquefier 20. The print head 18 can have any suitable configuration. In addition to the dual-tip embodiment as illustrated, examples of suitable devices for print head 18, and the connections between print head 18 and head gantry 36 include those disclosed in Crump et al., U.S. Pat. No. 5,503,785; LaBossiere, et al., U.S. Pat. No. 7,604,470; Swanson et al., U.S. Pat. Nos. 8,419,996 and 8,647,102; Batchelder U.S. Pat. No. 8,926,882; and Barclay et al. U.S. Pat. No. 10,513,104.

In one example, one or more filament loading drives is used to advance filament from a consumable assembly 12 into a flexible guide tube which forms the filament feed path 16, interconnecting the consumable assembly 12 and print head 18. The filament loading drive is located proximate an entryway to the printer, where filament is fed from the consumable assembly. The filament loading drive applies a force to the filament that pushes the filament along the filament feed path until it reaches the filament drive on the print head. The print head drive engages and pulls the filament from the guide tube and drives the filament into the liquefier. To unload filament from the printer, the filament loading drive operates in reverse, to remove filament from the print head and wind the engaged filament strand back into the consumable assembly. Examples of suitable devices for the filament loading drive include those disclosed in Nadeau et al., U.S. Pat. No. 10,494,219 and Smith et al., U.S. Patent Application Publication No. 2020/0282644

3D printer 10 also includes controller assembly 38, which may include one or more control circuits (e.g., controller 40) and/or one or more host computers (e.g., computer 42) configured to monitor and operate the components of 3D printer 10. For example, one or more of the control functions performed by controller assembly 38, such as performing move compiler functions, can be implemented in hardware, software, firmware, and the like, or a combination thereof; and may include computer-based hardware, such as data storage devices, processors, memory modules, and the like, which may be external and/or internal to system 10.

Controller assembly 38 may communicate over communication line 44 with print heads 18, filament drive mechanisms, chamber 28 (e.g., with a heating unit for chamber 28), head carriage 34, motors for platen gantry 32 and head gantry 36, and various sensors, calibration devices, display devices, and/or user input devices. In some embodiments, controller assembly 38 may also communicate with one or more of platen assembly 30, platen gantry 32, head gantry 36, and any other suitable component of 3D printer 10. While illustrated as a single signal line, communication line 44 may include one or more electrical, optical, and/or wireless signal lines, which may be external and/or internal to 3D printer 10, allowing controller assembly 38 to communicate with various components of 3D printer 10.

During operation, controller assembly 38 may direct platen gantry 32 to move platen assembly 30 to a predetermined height within chamber 28. Controller assembly 38 may then direct head gantry 36 to move head carriage 34 (and the retained print heads 18) around in the horizontal x-y plane above chamber 28. Controller assembly 38 may also direct print heads 18 to selectively advance successive segments of the consumable filaments from consumable assembly 12 through guide tubes 16 and into the liquefier 20.

FIG. 3 illustrates a 3D printer 100 that functions similarly to the printer 10 described in FIGS. 1 and 2 where the print heads are moved in a horizontal x-y plane and the platen is moved in a vertical z direction, and wherein one or more parts and associated support structures can be printed in a layer-by-layer manner by incrementally lowering the platen in the z direction. The printer 100 includes a large format platen 110 for building and supporting large 3D parts, such as wherein the build surface of the platen 110 has a surface area of about 400 sq. inches (e.g., 20 inches by 20 inches) or greater, including without limitation, a surface area of about 576 sq. inches (e.g., 24 inches by 24 inches), or a surface area of about 1280 sq. in (e.g., 32 inches by 40 inches). As illustrated, the printer 100 includes a container of part material 102 and a container of support material 104 supported in an opening 106 within the footprint of the printer 100 below a heated chamber 108.

The printer 100 includes a control panel 112 proximate a front surface 114 such that an operator can both visually monitor the status of the build process through a window 116 and the control panel 112. However, the filament loading from the containers 102 and 104 is through receptacles (described further herein) that are located in a back surface 116 of the printer 100, away from the control panel 112. The present disclosure allows the operator to monitor the status of the filament without reference to the control panel 112.

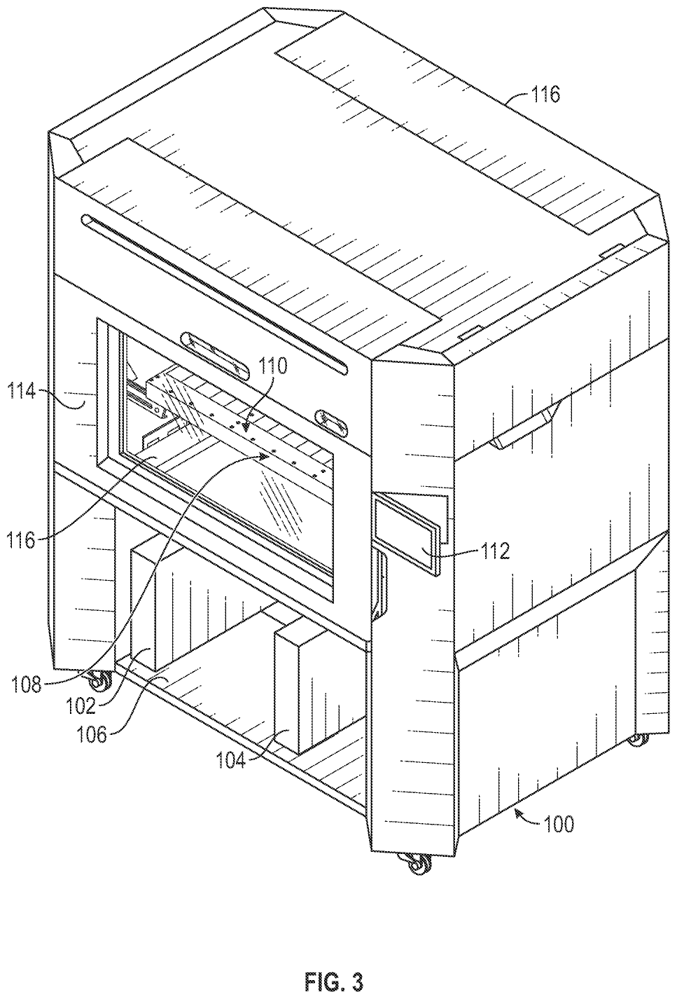

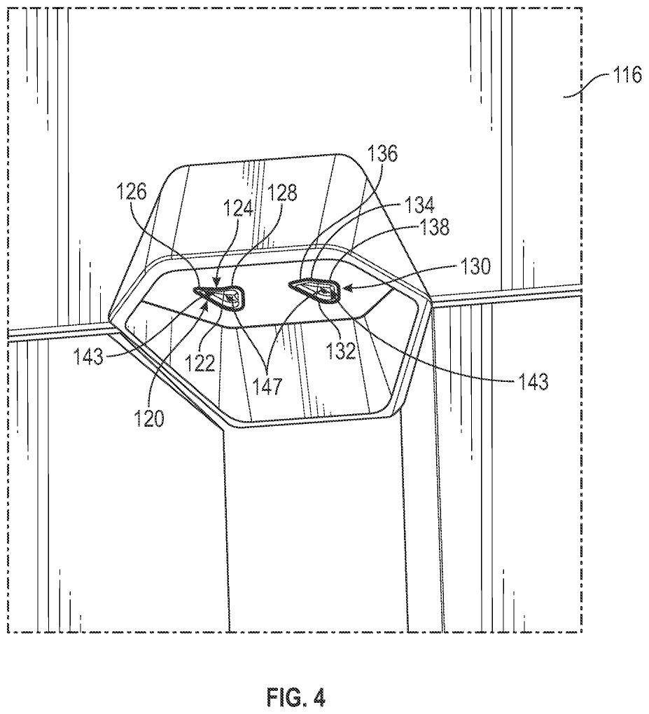

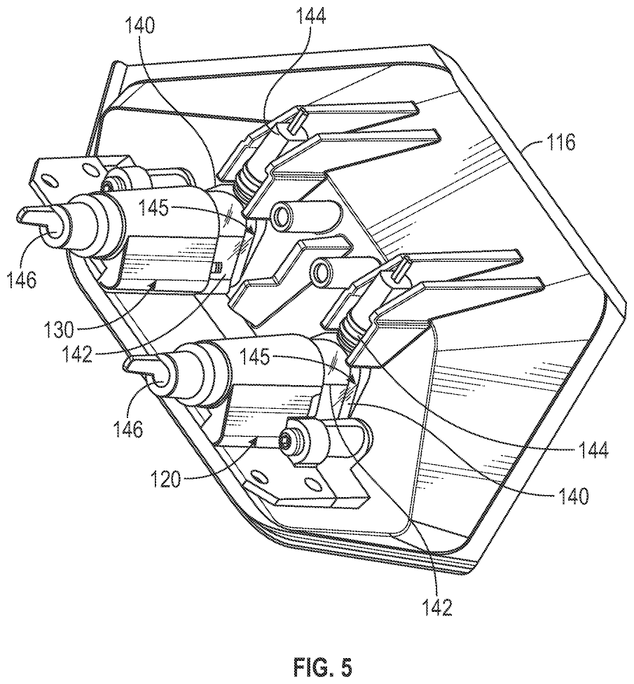

Referring to FIGS. 4 and 5, receptacles 120 and 130 in the filament feed paths 16p and 16s are illustrated. The receptacles 120 and 130 are configured to accept connectors or keys attached to a distal end of a filament guide tube having a proximal end connected to the container of part material 102 and the container of support material 104 and allow the filament to travel to the print head. As illustrated, the receptacles 120 and 130 have different configurations to only accept a key or connector with a complementary configuration, such that filament materials are sent to the desired print head. However, the receptacles 120 and 130 can be the same configuration.

The receptacle 120 includes an arcuate bottom portion 122 that connects with an upper portion 124 having downwardly sloped surfaces 126 and 128. The receptacle 130 includes an arcuate bottom portion 132 that connects with an upper portion 134 having upwardly sloped surfaces 136 and 138. However, the disclosed configurations of the receptacles are exemplary in nature, and can have any suitable configuration that accepts a key or connector of a complementary configuration.

Each receptacle 120 and 130 is similarly constructed, having a front portion 140 constructed of a light-transmissive material, a back portion 142 constructed of an opaque material, and an outlet 146 leading into the printer. A light emitting source 144 is positioned proximate the light-transmissive front portion 140, proximate an entrance 143 of each receptacle 120 and 130. A typical, non-limiting light emitting source 144 is a light emitting diode. As the light emitting source 144 in the exemplary embodiment is located proximate an outer surface 145 of each receptacle 120 and 130, the light emitting source 144 does not interrupt an inner surface 147 of the receptacles 120 and 130 which prevents unwanted wear on the connectors as the connectors are inserted into or removed from the receptacles 120 and 130.

The light emitting source 144 is configured to emit light signals through the light-transmissive front portion 140 such that light is emitted through the entrance 143 such that the light is visible when the connector 120 or 130 is displaced from the receptacle 120 and 130. The opaque back portion 142 aids in directly the light through the entrance.

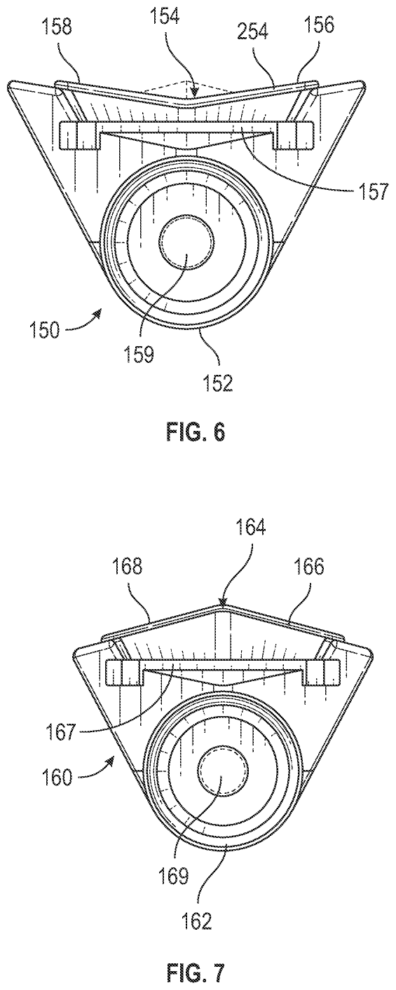

Referring to FIGS. 6 and 7, front views of keys or connectors are illustrated at 150 and 160. The connector 150 is configured to be positioned into the receptacle 120 and the connector 160 is configured to be positioned into the receptacle 130. The connector 150 has an arcuate bottom portion 152 that connects with an upper portion 154 that includes downwardly sloped surfaces 156 and 158. The configuration of the connector 150 is complementary to the configuration of the receptacle 120 and allows the connector to be inserted into and retained in the receptacle 120 and also be removed therefrom.

The connector 160 has a similar configuration to the receptacle 130 and includes an arcuate bottom surface 132 that connects with an upper surface 134 having upwardly sloped surfaces 136 and 138. The configuration of the connector 160 is complementary to the configuration of the receptacle 130 and allows the key or connector to be inserted into and retained in the receptacle 130 and also removed therefrom.

Connector 150 and connector 160 each have a channel 159 and 169, respectively, configured to allow filament to pass therethrough. The channels 159 and 169 are aligned with the outlets 146 of the receptacles 120 and 130 to allow the filament to be fed to the print head. Further, each of connector 150 and connector 160 includes a circuit board 157 and 167 that is configured to connect to a circuit board 127 and 137 within the receptacles 120 and 130, all respectively.

An exemplary light-transmissive material of construction for connectors 150 and 160 is an elastomeric material having a Shore A hardness in the range of about 30 to about 95, which provides sufficient rigidity to be inserted into the receptacles 120 and 130 and sufficient flexibility to form a seal with the receptacles 120 and 130. However, other materials of construction are within the scope of the present disclosure, as are other means of retaining the connectors in the receptacles (i.e., latches and other hardware may be used where the connectors are not self-sealing or self-retaining).

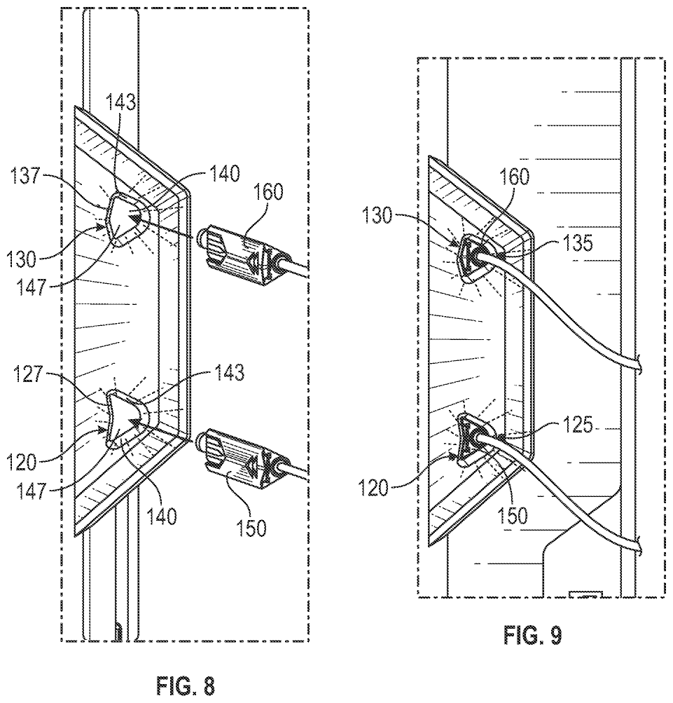

Referring to FIG. 8, the connector 150 and the connector 160 are displaced from the receptacles 120 and 130. The light emitting sources 144 are energized to emit light signals from the receptacles 120 and 130 and into the translucent or transparent first portion 140 of the receptacles 120 and 130. The light-transmissive material of the first portion 140 allows light from the light emitting source 144 to be emitted through the entire volume of the first portion 140 such that the receptacles 120 and 130 are illuminated to provide a visual signal to the operator. Due to the design of the receptacles 120 and 130 and the location of the light emitting source 144 relative to the receptacles 120 and 130, a relatively small light emitting source 144 can cause a relatively large area or volume to be illuminated.

Referring to FIG. 9, connector 150 and connector 160 are illustrated within the receptacles 120 and 130. Because the connectors 150 and 160 are constructed of the light-transmissive material, the light emitted from the first portion 140 of the receptacles 120 and 130 is transmitted into the connectors 150 and 160 and is emitted from the connectors 150 and 160 to provide a visual signal that is the size of the connector 150 and 160 that can be easily viewed.

By way of example, visual signals can be provided based upon the color emitted, a rate at which the light is blink or is a solid light. Visual signals are disclosed and illustrated being provided through the receptacles 120 and 130 and visible through the inserted connectors 150 and 160.

When the connector 150 or 160 is inserted into the receptacle 120 or 130, contacts on the circuit boards 156 and 166 engage contacts 127 and 137 in the receptacles 120 or 130 to allow the circuit board 156 and 166 to communicate with the controller or computer of the additive manufacturing system 10 and 100. The circuit boards 156 and 166 can provide information to the printer about the type of material, the diameter of the filament and/or the length of the filament in the feedstock supply 12, 102 and 104, by way of non-limiting example, such as is described in Stratasys U.S. Pat. No. 6,022,207 and MakerBot U.S. Pat. No. 9,233,504. In other embodiments, the circuit boards 156 and 166 can be secured elsewhere on the connectors 150 and 160 in other manners that will provide a communication with the printer, or can be omitted if the printer does not require or utilize the circuit board functionality.

The light emitting sources 144 are typically controlled by the controller or through a circuit associated with the contacts on the circuit boards 157 and 167 with the connectors 127 and 137 in the receptacles 120 and 130. However, the LEDs can be controlled by other control mechanisms.

It can be difficult to load and unload filament on the back side of the printer, due to lack of proximity with instructions and status information communicated via the control panel on the front side of a printer. This is particularly true of a large-scale 3D printer, where it is not possible to see or to reach the filament feed area of a printer while standing at the front control panel. Without a localized way of communicating printer filament feed status while being at the area to feed it, it becomes difficult to understand whether a filament loading drive is ready for loading, unloading, or in need of trouble-shooting. The present invention solves this problem by offering a local mode of communication at the location of the filament feed. With the implementation of signaling lights at the receptacle, the operator no longer needs to travel back and forth to determine when the printer has moved from one filament loading status to the next. In addition, with a highly visible filament connector light signaling system, the operator does not need to be in close proximity of the printer to view the lights, and thus the operation or maintenance statuses related to filament feeding.

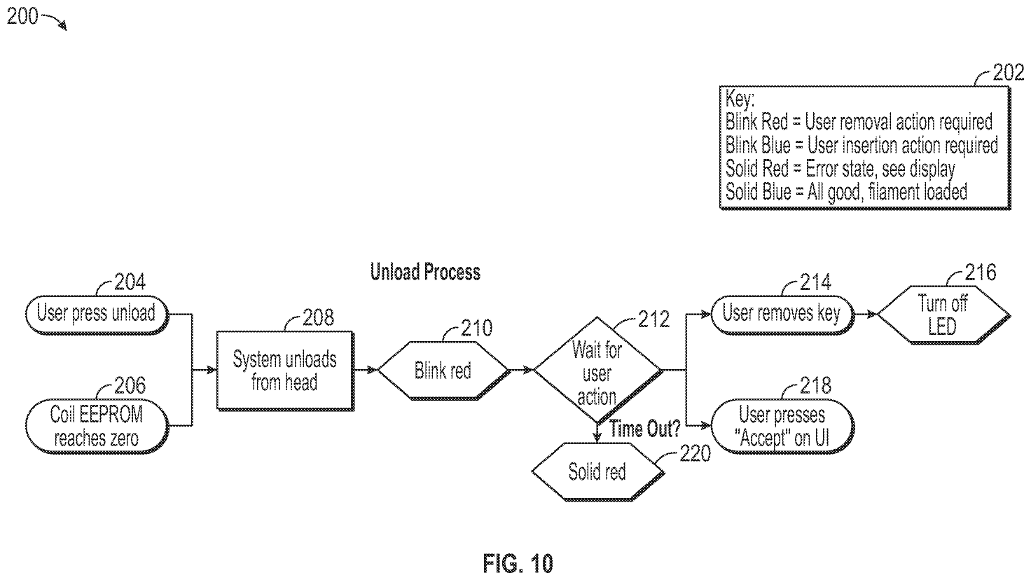

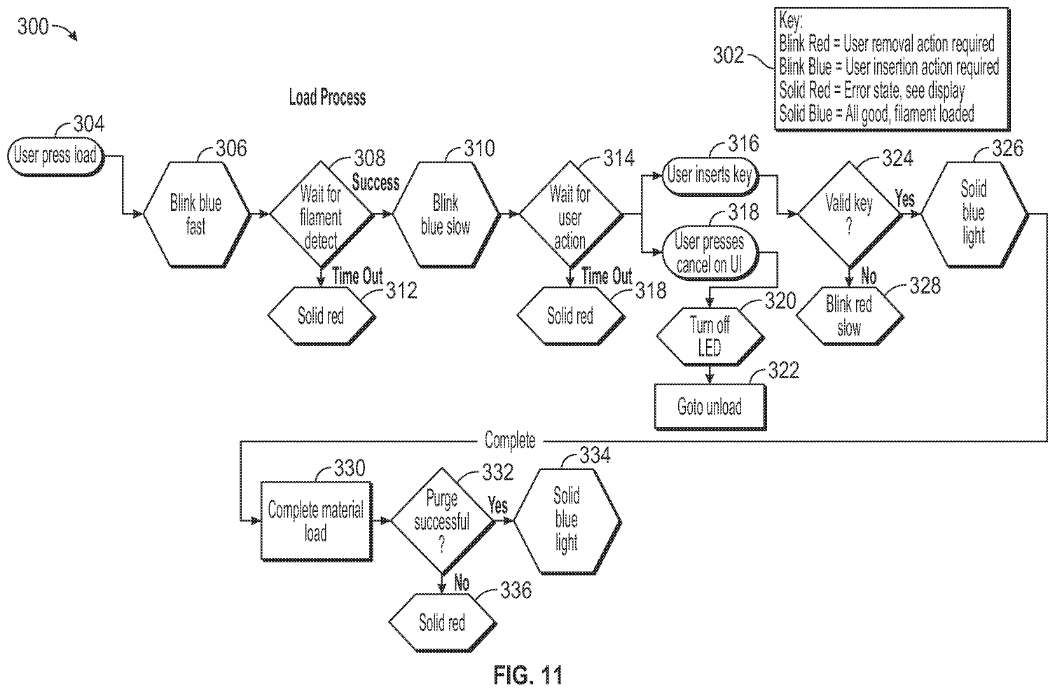

Referring to FIG. 10, a filament unloading process is illustrated at 200. The filament unloading process includes a signal key 202 that aids the operator to understand the meaning of signals being sent by color and whether the light is blinking or solid.

The unloading process 200 is initiated by the operator using the controller or user interface at the front of the machine control panel, to start the unloading process at 204. Alternatively, if memory relating the amount of filament remaining in supply 102 or 104 such as, but not limited to electrically erasable programmable read-only memory (EEPROM) indicates that there is no remaining filament in the supply 102 or 104, then the unloading process is initiated at step 406.

Once the step 204 or 206 is initiated, the filament begins to unload from the print head at step 208 and the LED 146 begins to emit a blinking red light at step 210 indicating to the operator that step 208 has commenced and that an action by the operator is required. Once the red light begins blink at step 210, the process waits for action by the operator at step 212. If action is taken in the allotted time, such as the operator removing the connector 150 or 160 from the receptacle 120 or 130, respectively, at step 414, then the LED 146 turns off at step 216, such that no light is emitted and transmitted through the receptacle and connector, and optionally through a portion of the filament feed tube.

Alternatively, if the user acknowledges that the filament is removed from the print head at step 218, the unloading process 200 is determined to be complete.

Referring back to step 212, if the operator does not take action within the allotted time, the process times out and a solid red light is emitted at step 220, through the connector 150 or 160. The bright emitted solid red light in step 220 signals to the operator that immediate action is required.

Referring to FIG. 11, a filament loading process is illustrated in FIG. 300. The filament loading process 300 includes a signal key 302 that the same or similar to the signal key 202 of the filament unloading process 200 so the operator understands the meaning of the signals being sent by color and whether the light is blinking or solid. The color and blinking variation lighting changes are visibly accentuated by transmitting from the receptacle and/or illuminating the filament connector. Alternately, source of the light could be internally sourced within the connector, and/or within a portion of the filament feed tubing, if it is also light transmissive.

The operator initiates the loading process 300 by manipulating an interface on the controller at step 304. A blue light begins blinking at a first rate at step 306 indicating to the operator that action is required in the loading process. The blue light remains blinking for a period of time while waiting to detect that filament is either manually fed through the filament tube 16 or is driven by a loading drive from the supply 102 or 104 though the filament tube 16.

If the filament is detected in the filament path, typically either at the filament loading drive between the print head and the receptacle or proximate the filament drive mechanism on the print head, then the blue light blinks as a second rate, that is different from the first rate, indicating that the filament has been detected and further action is required by the operator at step 310. In an exemplary embodiment the second rate is slower than the first rate. However, the second rate can be faster than the first rate If the filament is not detected at step 308, then the light turns to a solid red at step 312 indicating to the user that there was an error in the filament loading process and to reference the error at the control panel

As the blue light is blinking at the second rate, the process 500 waits for the operator to act at step 314. If the operator acts within an allotted time by insert a connector 150 or 160 into the receptacle 120 or 130, respectively, at step 516, then the loading process continues. If no action is taken within the allotted time, then a red solid light is emitted at step 318, indicating that there was an error in the filament loading process and to reference the error at the control panel. Alternatively, the operator can use the control panel to cancel the loading process at step 318 which leads to the lights being turned off at step 320 and the unloading process 200 being initiated at step 322.

A determination is made whether the connector 150 or 160 within the receptacle 120 or 130, respectively, is valid at step 324. If the connector is validated, the light turns to a solid blue light at step 326 indicating that the filament was successfully loaded. If a determination is made that the connector was invalidated, the emitted light turns to a blinking red light at step 328, indicating that the operator is to begin the filament unloading process 200.

With a solid blue light being emitted at step 326, the filament loading is indicated as complete at step 530. A typical purging step is performed in the print head to get the print head ready to extrude material and print part or support structures at step 332. If the purging step is successful, then the solid blue light remains emitted at step 334, meaning that the filament can be used for printing.

If the purging step 332 is unsuccessful, then a solid red light is emitted at step 336. The solid red light in step 336 indicates to the operator to view the control panel or user interface. The user interface will then instruct the operator to start the filament unloading process as disclosed at 200 in FIG. 10.

As illustrated and disclosed, the present system and method provides visual signals to the operator regarding the actions to be taken by using two colors, red and blue light, and whether the light is blinking or solid. The blinking red light indicates that the operator removes the filament. The blinking blue light indicates that the operator action is required to load the filament, where at typical, non-limiting first rate is at 0.166 second intervals and the second non-limiting second rate is at 0.5 second intervals. The solid red light instructs the operator to view the user interface as an error was detected. The solid blue light indicates that the filament was properly loaded.

While blinking or solid red and blue light are utilized to provide four visual signals indicating the status of the loading and unloading processes and whether action is needed, other signals could also be provided. For instance, a different solid color could be emitted for each visual signal. Alternatively, a signal color with different emitting patterns could be emitted for each of the four visual signals. Also, a variety of blinking patterns can convey different statuses, such as a slow blink or a fast blink, or a series of slow and fast blinks to convey numerical patterns. The numerical patterns could be decoded through the use of a number/function chart.

Additionally, other signals could also be provided proximate the receptacle of the 3D printer such as different sounds and a combination of light and sound. Additionally, any distinct signal relating to a required action for loading, a distinct signal for action required for unloading, a distinct signal for an error in loading, unloading or inability to print or combinations thereof and another distinct signal indicating that the filament was successfully load, ready for print and combinations thereof. The present disclosure is not limited to the use of two colors and/or action required for loading and unloading.

Additionally, while four signals are disclosed, the present disclosure can utilize any of a plurality of signals, provided the operator is provided information to determine the action required by each signal and/or success or failure of a loading or unloading process of the filament.

Although the present disclosure may have been described with reference to preferred embodiments, workers skilled in the art will recognize that changes may be made in form and detail without departing from the spirit and scope of the disclosure.

1. A 3D printer comprising:
a print head configured to receive a filament, melt the filament, and deposit the melted filament to form a 3D part;
a filament supply comprising:
a container configured to retain a supply of a filament;
a filament guide tube having a length, the filament guide tube comprising:
an inlet end attached to the container; and
an outlet end; and
a plug-in connector secured to the outlet end of the filament guide tube, the connector constructed of at least partially of a light-transmissive material;
a receptacle spaced from the print head, the receptacle comprising a conduit having an entrance for accepting the outlet end of the filament guide tube and an exit for passing the filament toward the print head; and
a light source proximate the receptacle wherein the light source is configured to emit a light signal proximate the receptacle, such that when the connector is inserted into the receptacle, light shines through the connector to inform the operator of a filament loading status.

2. The 3D printer of claim 2, wherein the light signal is emitted through the light source in communication with the receptacle.

3. The 3D printer of claim 1, wherein the light signal is emitted through a plurality of light sources in communication with the receptacle.

4. The 3D printer of claim 1, wherein the receptacle is at least partially constructed of a light-transmissive material

5. The 3D printer of claim 1, wherein the light signal communicates information through colors, pulsing frequency, or both.

6. The 3D printer of claim 5, wherein the light signal comprises a blinking light and a solid light of a first color being emitted.

7. The 3D printer of claim 5, wherein the light signal further comprises a blinking light and a solid light of a second color being emitted.

8. The 3D printer of claim 1, wherein the 3D printer comprises:
a plurality of print heads;
a plurality of receptacles; and
a plurality of filament supplies wherein each filament supply include a plug-in connector configured to be inserted into each of the plurality of receptacles; and
a plurality of light sources, at least on proximate each receptacle, wherein each of the plurality of light sources is configured to emit a light signal proximate each receptacle such that when each connector is inserted into each receptacle, light shines through each connector to inform the operator of a filament loading status.

9. The 3D printer of claim 1, wherein causing the light signal to be emitted comprises:
emitting a first signal type indicative of a filament loading or unloading process; and
emitting a second signal type when an error state is encountered.

10. The method of claim 9, wherein causing the light signal to be emitted further comprises:
emitting a third signal type indicative that the filament is in use or ready for use in a printing process.

11. The method of claim 10, wherein causing the light signal to be emitted further comprises:
emitting a fourth signal type indicative of a print head purge operation.

12. A method of monitoring status of a 3D printer, the method comprising:
providing a 3D printer having a print head configured to receive a filament, melt the filament, and deposit the melted filament to form a 3D part, and having a receptacle configured for accepting a plug-in connector from a filament supply;
providing a filament supply comprising:
a container configured to retain a supply of a filament;
a filament guide tube having a length, the filament guide tube comprising:
an inlet end attached to the container; and
an outlet end;
a connector constructed of a light-transmissive material and having a first geometric configuration allowing the connector to be inserted into the receptacle and comprising a conduit having an entrance for accepting the outlet end of the filament guide tube and an exit for passing the filament toward the print head; and
inserting the connector into the receptacle;
causing a light signal to be emitted proximate the receptacle, such that when the connector is inserted into the receptacle light shines through the connector to inform the operator of a filament loading status.

13. The method of claim 12, wherein the light signal is emitted through a light source in communication with the receptacle.

14. The method of claim 13, wherein the light signal is emitted through a plurality of light sources in communication with the receptacle.

15. The method of claim 12, wherein the receptacle is at least partially constructed of a light-transmissive material

16. The method of claim 12, wherein the light signal communicates information through colors, pulsing frequency, or both.

17. The method of claim 17, wherein the light signal comprises a blinking light and a solid light of a first color being emitted.

18. The method of claim 17, wherein the light signal further comprises a blinking light and a solid light of a second color being emitted.

19. The method of claim 12, wherein the printer has a plurality of receptacles, and wherein providing a filament supply comprises providing a plurality of filament supplies and inserting the plug-in connector of each filament supply into one of the plurality of receptacles.

20. The method of claim 12, wherein causing the light signal to be emitted comprises:
emitting a first signal type indicative of a filament loading or unloading process; and
emitting a second signal type when an error state is encountered;
emitting a third signal type indicative that the filament is in use or ready for use in a printing process; and
emitting a fourth signal type indicative of a print head purge operation.
